(19) United States
(12) Patent Application Publication
(10) Pub. No.: US 2024/0211850 A1
(43) Pub. Date: Jun. 27, 2024

(54) SECURE DATA PHYSICAL DELIVERY

(71) Applicant: AT&T Intellectual Property I, L.P., Atlanta, GA (US)

(72) Inventors: Howard L. Lang, Wayside, NJ (US); Joseph Soryal, Glendale, NY (US)

(21) Appl. No.: 18/146,457

(22) Filed: Dec. 26, 2022

(51) Int. Cl. G06Q 10/0833

(52) U.S. Cl. CPC G06Q 10/0833

(57) ABSTRACT

A processing system including at least one processor may load a proposed transaction to at least one uncrewed vehicle while the at least one uncrewed vehicle is situated in a first geographical region, instruct the at least one uncrewed vehicle to travel to at least one access point situated in a second geographical region to execute the proposed transaction via the at least one access point, wherein the first geographical region is different from the second geographical region, and receive a result of the proposed transaction having been completed from the at least one uncrewed vehicle via the at least one access point.

The present disclosure relates generally to uncrewed vehicle operations, and more particularly to methods, computer-readable media, and apparatuses for providing secure data (e.g., a proposed transaction) delivery via an uncrewed vehicle, e.g., based upon regional or jurisdictional boundaries.

### BACKGROUND

Current trends in communication technology are leading towards a future where virtually any transactions can be performed or must be performed over a network. Such transactions over a network often necessitate the transport of confidential or proprietary data between two parties. Such transactions may encompass a financial transaction (e.g., the trading of a stock or a cryptocurrency or the movement of funds), personalized transaction of an individual (e.g., sending/receiving of: medical records, Internet searches and respective search results, financial records, private communications such as texts and emails, presence or location information, and the like), and personalized transaction of a corporate or governmental entity (e.g., sending/receiving of: employment records, corporate financial records, private communications such as texts and emails of employees, presence or location information of employees, and the like). Thus, a wealth of proprietary data are often transacted on a daily basis that may be vulnerable to malicious attacks such as data theft or data blackmail. Additionally, as such network-based transactions become more prevalent and entrenched, the lack of network access will also become a major problem where network access is spotty or even nonexistent.

### SUMMARY

In one example, the present disclosure describes a method, computer-readable medium, and apparatus for providing secure data delivery. For example, a processing system including at least one processor may load a proposed transaction to at least one uncrewed vehicle while the at least one uncrewed vehicle is situated in a first geographical region, instruct the at least one uncrewed vehicle to travel to at least one access point situated in a second geographical region to execute the proposed transaction via the at least one access point, wherein the first geographical region is different from the second geographical region, and receive a result of the proposed transaction having been completed from the at least one uncrewed vehicle via the at least one access point.

### BRIEF DESCRIPTION OF THE DRAWINGS

The teaching of the present disclosure can be readily understood by considering the following detailed description in conjunction with the accompanying drawings, in which:

FIG. 1 illustrates an example system related to the present disclosure;

FIG. 2 illustrates an example of a transaction application for supporting a method for providing secure data delivery, in accordance with the present disclosure;

FIG. 3 illustrates a flowchart of an example method for providing secure data delivery, in accordance with the present disclosure; and

FIG. 4 illustrates an example high-level block diagram of a computing device specifically programmed to perform the steps, functions, blocks, and/or operations described herein.

To facilitate understanding, identical reference numerals have been used, where possible, to designate identical elements that are common to the figures.

### DETAILED DESCRIPTION

In one example, the present disclosure discloses a method, computer-readable medium, and apparatus for providing secure data delivery. In particular, examples of the present disclosure provide a system that manages the execution of proposed transaction via the use of uncrewed vehicles (e.g., “unmanned” vehicles (or also referred to as devoid of an onboard operator of the vehicle), e.g., unmanned aerial vehicles (UAVs), submersibles, surface travelling vehicles, etc.). In accordance with the present disclosure, an uncrewed vehicle may be remotely controlled by a human or an autonomous system, or may be self-operating or partially self-operating (e.g., a combination of on-vehicle and remote computing resources).

There are many different types of proposed transactions. In the context of financial transactions, proposed transactions may encompass: the trading of securities (such as stocks, bonds, options, mutual funds and/or other financial instruments); the movement of funds (e.g., the transfer of money from one account to another account); the trading of cryptocurrency (also known as crypto), and the like. For example, the parameters of these financial transactions may comprise at least one of: the identity of the securities involved in the transaction, the dollar value of the securities involved in the transaction, the financial institutions where the securities involved in the transaction are stored, the asking/selling price of the securities involved in the transaction, the actual digital crypto itself, and the like. Since such financial transactions often involve a substantial amount of money and also expose private financial information pertaining to an individual, protecting such sensitive financial transaction is very important to a user.

More importantly, the vulnerability of cryptocurrency poses an additional challenge in that the actual cryptocurrency itself can be stolen or compromised in some way that can be effected remotely and electronically. In other words, a hacker may break into an account online and steal the actual cryptocurrency remotely. Thus, cryptocurrency can be stored in a “cold” wallet (i.e., the storage device is not connected to any network), or can be stored in a “hot” wallet (i.e., the storage device is connected online to a network in some fashion). The use of the “cold” wallet is intended to prevent the theft of the cryptocurrency by a hacker who may infiltrate an account stored in a network from afar. However, although usage of the cold wallet is a very effective security mechanism to protect the cryptocurrency, it still poses a significant challenge when the user attempts to trade the cryptocurrency. For example, a user may allow the cold wallet to temporarily be connected to a network for the duration of effecting the trading of the cryptocurrency, but even such temporary connection may expose risky access to the cold wallet which may hold a large sum of cryptocurrency that will become vulnerable to attacks.

In the context of personal transactions, proposed transactions may encompass: a high level discussion (e.g., emails, texts, voicemail and the like) between corporate executives as to: the merging of corporate entities, the negotiation of a license or a settlement, the potential purchase of a corporate asset, and the like; a discussion with medical or legal professionals (e.g., emails, texts, voicemail and the like) by a user who is seeking advises on medical diagnoses and treatments (e.g., mental illnesses) or legal advises (e.g., divorce proceedings); or sensitive Internet searches (e.g., advises on reproductive care issues). Protecting such highly sensitive personal transaction is very important to a user. Inadvertent or maliciously leakage of such personal transactions may cause dire consequences to the affected individuals or corporate entities.

In the context of isolated transactions, proposed transactions may encompass: a request for assistance due to a medical emergency, critical coordination communications between first responders, combat communications between different fighting units, and the like. There are many different scenarios where a user may be isolated due to the lack of network connectivity. For example, a user may live in a sparsely populated area, e.g., in the Alaska back country, where there are no landline or wireless network connectivity for many miles from a location of the user. In another scenario, first responders may be deployed into a remote area to address a particular emergency, e.g., fire fighters being airlifted deep into a forest to fight a forest fire. In another scenario, a combat unit may be deployed into a remote area to perform a particular mission, e.g., a forward unit being deployed in a forward area or even behind an enemy line to scope out enemy positions. Executing such isolated transactions is very important to a user who may: need immediate medical attention, need to coordinate with other first responders in a hostile environment, or need to report critical real time information back to a higher command structure or to other combat units in the field.

In accordance with the present disclosure, examples of the present disclosure utilizes one or more uncrewed vehicles to execute a proposed transaction (broadly a proposed transaction). In one example, the present disclosure may detect the initiation of a proposed transaction and captures or stores at least one parameter of the proposed transaction. More specifically, the proposed transaction comprises at least one task that must be performed relating to the at least one parameter. To illustrate, a proposed transaction may comprise: trading (a task) a cryptocurrency (a first parameter) for a specified price (a second parameter); trading (a task) a security (a first parameter) for a specified price (a second parameter) for today only (a third parameter); sending (a task) a message (a first parameter) to another executive (a second parameter) of a corporate entity (a third parameter); searching (a task) in the Internet for a divorce attorney (a first parameter) in a particular geographic region (a second parameter); searching (a task) in the Internet for a medical professional or clinic (a first parameter) in a particular geographic region (a second parameter), for a particular medical condition (a third parameter); requesting (a task) emergency assistance for medical assistance (a first parameter) in a particular remote geographic region (a second parameter); or sending (a task) images of opponent units along a particular front line or location (a first parameter). It should be noted that the above list of proposed transactions is only provided as an illustration and the present disclosure is not so limited.

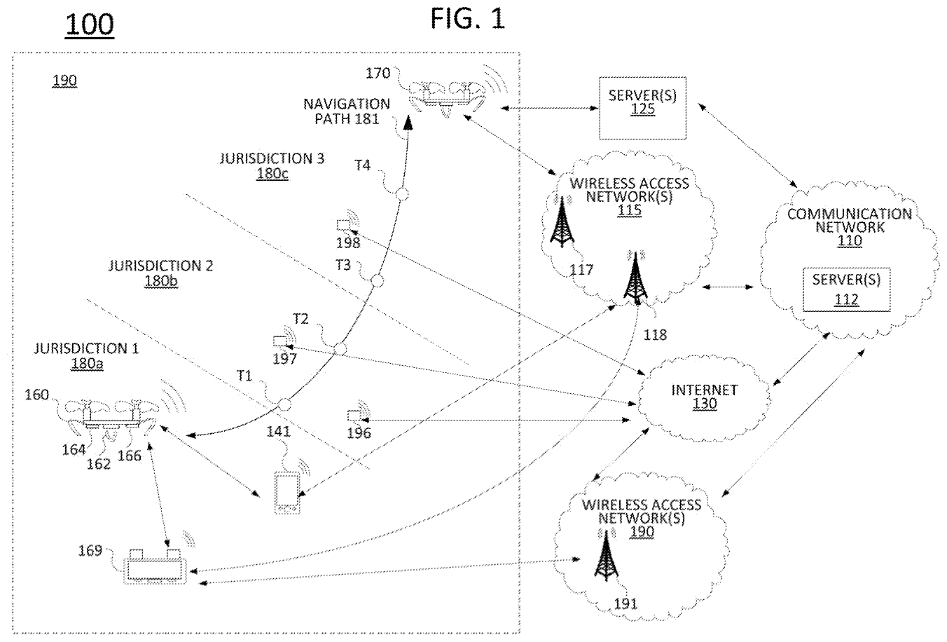

Once the particulars of the proposed transaction have been captured or stored (e.g., a software script outlining the task(s) to be performed and the pertinent parameter(s) associated with the task(s)), the proposed transaction is uploaded to the uncrewed vehicle. The uncrewed vehicle is then instructed to travel to a designated remote access point (e.g., at a different jurisdiction from a current jurisdiction of the user sending the uncrewed vehicle) for executing the proposed transaction. Once the proposed transaction is completed at the designated remote access point, the uncrewed vehicle will return with the proposed transaction result that can then be communicated to a local processing unit (e.g., a desktop computer, a laptop computer, a smart phone, a tablet computing device and the like) of the user. These and other aspects of the present disclosure are discussed in greater detail below in connection with the examples of FIGS. 1-4.

To aid in understanding the present disclosure, FIG. 1 illustrates an example system 100, related to the present disclosure. As shown in FIG. 1, the system 100 connects mobile device 141, server(s) 112, server(s) 125, uncrewed vehicles, e.g., uncrewed aerial vehicles (UAVs 160 and 170), and access points 196-198 (e.g., comprising fixed-location access points with computing and communication resources) with one another and with various other devices via a core network, e.g., a communication network 110, a wireless access network 115 (e.g., a cellular network), and Internet 130.

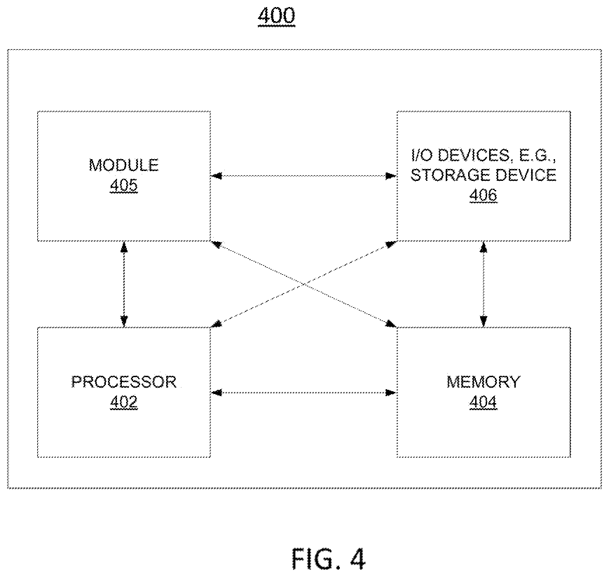

In one example, the server(s) 125 may each comprise a computing device or processing system, such as computing system 400 depicted in FIG. 4, and may be configured to provide one or more functions in connection with examples of the present disclosure for providing secure data (e.g., a proposed transaction) delivery via an uncrewed vehicle. For example, mobile device 141 or remote control device 169 may be configured to perform one or more steps, functions, or operations in connection with the example method 300 described below. In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device, or computing system, including one or more processors, or cores (e.g., as illustrated in FIG. 4 and discussed below) or multiple computing devices collectively configured to perform various steps, functions, and/or operations in accordance with the present disclosure.

In one example, server(s) 112 or 125 may receive and store proposed transaction information (e.g., the type of proposed transaction and corresponding transaction parameters), access point information (e.g., the access point that the UAV interacted with to execute the proposed transaction, the identity of the access point, the physical or logical location of the access point, the owner of the access point, etc.), and/or UAV information (e.g., the identity of the UAV, the owner of the UAV, the capability of the UAV, the current location of the UAV, UAV location relative to a particular access point, a flight plan or route of an UAV, and so on) from UAVs 160 and 170, e.g., via access points 196-198 via connections over the Internet 130 or network 110. In another example, server(s) 125 or 112 may also receive and store proposed transaction information and/or access point information from mobile device 141, remote control device 169 and UAVs 160 and 170, e.g., via wireless access network(s) 115, communication network 110, and/or the Internet 130. For instance, the server(s) 125 or 112 may include server(s) of an uncrewed vehicle monitoring service, in accordance with the present disclosure. In one embodiment, the UAVs 160 and 170 are owned by individuals who are performing the proposed transactions. Alternatively, the UAVs 160 and 170 are owned by a third party, e.g., a corporate entity or a governmental entity, that are providing proposed transaction services to individuals who may be situated in isolated areas, or who may simply do not have their own UAVs.

In one example, the system 100 includes a communication network 110 (e.g., a telecommunication network). In one example, communication network 110 may comprise a core network, a backbone network or transport network, such as an Internet Protocol (IP)/multi-protocol label switching (MPLS) network, where label switched routes (LSRs) can be assigned for routing Transmission Control Protocol (TCP)/IP packets, User Datagram Protocol (UDP)/IP packets, and other types of protocol data units (PDUs), and so forth. It should be noted that an IP network is broadly defined as a network that uses Internet Protocol to exchange data packets. However, it will be appreciated that the present disclosure is equally applicable to other types of data units and transport protocols, such as Frame Relay, and Asynchronous Transfer Mode (ATM). In one example, the communication network 110 uses a network function virtualization infrastructure (NFVI), e.g., host devices or servers that are available as host devices to host virtual machines comprising virtual network functions (VNFs). In other words, at least a portion of the communication network 110 may incorporate software-defined network (SDN) components.

As shown in FIG. 1, communication network 110 may also include one or more servers 112. In one example, each of the server(s) 112 may comprise a computing device or processing system, such as computing system 400 depicted in FIG. 4 and may be configured to provide one or more functions for providing secure data delivery via an uncrewed vehicle, in accordance with the present disclosure. For example, one or more of: the mobile device 141, the remote control device 169, the server(s) 112 or 125 may be configured to perform one or more steps, functions, or operations in connection with the example method 300 described below. For instance, the mobile device 141, the remote control device 169, and/or the server(s) 112 may collaborate to perform the various steps of the present method for providing secure data delivery via an uncrewed vehicle. In one embodiment, the mobile device 141, the remote control device 169, and/or the server(s) 112 or 125 may collectively or individually store and track the proposed transaction information, the access point information, and/or UAV information.

In addition, server(s) 112 or 125 may collect, store, and process location information and visual information, e.g., from UAVs 160 and 170, which may be utilized in connection with the example method 300 described herein. For example, visual information can be used to verify that the UAV is performing the proposed transaction at the proper access point or is performing the proposed transaction at the proper access point without malicious interference. For example, if an UAV is physically intercepted by a malicious user, the visual information communicated from the impacted UAV will allow the mobile device 141, the remote control device 169, and/or the server(s) 112 or 125 to void or abandon the execution of a proposed transaction. In other words, since the UAV is tasked with the important mission of executing the proposed transaction, there is a possibility that malicious users may intercept such UAVs while the UAVs are in transit or while the UAVs are in the process of completing the proposed transactions while communicating with the access point. The visual information along with location information, e.g., from UAVs 160 and 170, will allow the mobile device 141, the remote control device 169, and/or the server(s) 112 or 125 to confirm that the UAVs were not physically handled by unknown individuals while performing the proposed transaction.

In one example, server(s) 125 may include a weather data server (WDS). In such an example, weather data may be obtained by server(s) 112 from server(s) 125 via a weather service data feed, e.g., a National Weather Service (NWS) extensible markup language (XML) data feed, private or home weather stations, or the like. In another example, the weather data may be obtained by retrieving the weather data from the WDS. It should be noted that in one example, server(s) 112 and/or server(s) 125 may receive and store weather data from multiple parties. Such weather data can be utilized to determine a proper navigation path to and from the access point to ensure safe travel for the UAVs 160 and 170, e.g., to avoid a stormy area, to change its departure time, to change an initial assigned destination access point to an alternate destination access point, and so on.

In addition, in one example, mobile device 141, remote control device 169, or server(s) 112, or 125 may include a geographic information system (GIS). For instance, server(s) 125 may provide a digital elevation model (DEM), which may comprise a set of raster files or other format files, that records elevations for a set of given points (latitude, longitude). For instance, the digital elevation model may comprise Shuttle Radar Topography Mission (SRTM) data, which may provide measurements of elevation (e.g., relative to mean sea level (MSL)) in 1 arc-second, 30 meter resolution. In one example, the digital elevation model may be maintained by a commercial provider, such as Forsk Atoll, and so forth. Accordingly, in one example, server(s) 112 may obtain and store topology information (e.g., for jurisdictions or geographical regions 180a-c) from server(s) 125. For instance, server(s) 112 may store a digital elevation model for regions 180a-c. In one example, the digital elevation model may comprise a composite of digital elevation models from multiple sources. For instance, the STRM digital elevation model may comprise a primary source, while a more refined secondary digital elevation model may be used to supplement the STRM digital elevation model in certain regions or markets (e.g., in cities, particularly those with varying terrain, etc.) to provide a composite digital elevation model. Such elevation information can be conveyed to the UAVs for use in traversing the navigation path. For ease of illustration, various additional elements of telecommunication network 110 are omitted from FIG. 1.

In one example, one or more wireless access networks 115 may each comprise a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network(s) 115 may each comprise an access network in accordance with any “second generation” (2G), “third generation” (3G), “fourth generation” (4G), Long Term Evolution (LTE), “fifth generation” (5G), or any other existing or yet to be developed future wireless/cellular network technology. While the present disclosure is not limited to any particular type of wireless access network, in the illustrative example, base stations 117 and 118 (broadly access points) may each comprise a Node B, evolved Node B (eNodeB), or gNodeB (gNB), or any combination thereof providing a multi-generational/multi-technology-capable base station. In the present example, mobile device 141, remote control device 169, and/or UAVs 160 and 170 may be in communication with base stations 117 and 118, which provide network connectivity to UAVs 160 and 170, mobile device 141, remote control device 169 with other endpoint devices within the system 100, various network-based devices, such as server(s) 112, server(s) 125, and so forth. In one example, wireless access network(s) 115 may be operated by the same service provider that is operating telecommunication network 110, or one or more other service providers. Thus, the access points 196-198 of FIG. 1 can be found in one or more wireless access networks (not shown) such as the wireless access network(s) 115.

In another example, the access points 196-198 of FIG. 1 can be found in a decentralized network. For example, decentralized cellular access points (broadly access points), or “independent gateways” may be owned by individuals or enterprises, and may interface with and provide access to a cellular core network. In one example, independent gateway owners may earn rewards (e.g., monetary rewards, cryptocurrency, discounts/offsets of subscriber network access fees, etc.) based on the volume of data carried by each independent gateway, such as a number of dollars, cents, and/or tokens for each gigabyte (GB) of data, for instance.

In one example, system 100 may also include an access network 190 with an eNodeB (eNB) 191, e.g., an “independent gateway,” (broadly an access point) which may comprise an antenna unit and/or baseband unit, or the like. The eNodeB 191 may comprise, for example, a home eNodeB (HeNB), a “small cell,” such as a femtocell, a microcell, etc., and/or a “low power” eNodeB. For instance, eNB 191 may have a range of 2 kilometers or less, while eNodeBs 117 and 118 may have a range of up to 35 kilometers or more. In one example, eNB 191 may operate in a designated citizens broadband radio service (CBRS) spectrum (e.g., in the United States, this may comprise a 3.5 GHz band (3550-3700 MHz)). In one example, eNB 191 may utilize at least a portion of this spectrum in accordance with a registered priority access or general authorized access according to a spectrum access system (SAS). In one example, access network 190 and eNB 191 may connect to an evolved packet core (EPC) network (not shown) via a subscriber/customer broadband connection. For instance, access network 190 may comprise a home network of a customer/subscriber and eNodeB 191 may connect via a home gateway (not shown) or similar equipment deployed at the customer premises to a Serving Gateway (SGW) and Mobility Management Entity (MME) in the EPC network, e.g., via S1 interfaces. While access network 190 may comprise a home network, eNodeB 191 may continue to be managed by the communication service provider network 110, or may be managed by a customer/subscriber associated with access network 190. Thus, in one example, the access points 196-198 of FIG. 1 can be found in the decentralized access network 190.

As illustrated in FIG. 1, the mobile device 141 may comprise, for example, a cellular telephone, a smartphone, a tablet computing device, a laptop computer, a wireless enabled wristwatch, or any other wireless and/or cellular-capable mobile telephony and computing devices (broadly, a “mobile device” or “mobile endpoint device”). In one example, mobile device 141 may be equipped for cellular and non-cellular wireless communication. For instance, mobile device 141 may include components which support peer-to-peer and/or short range wireless communications. Thus, the mobile device 141 may include one or more radio frequency (RF) transceivers, e.g., for cellular communications and/or for non-cellular wireless communications, such as for IEEE 802.11 based communications (e.g., Wi-Fi, Wi-Fi Direct), IEEE 802.15 based communications (e.g., Bluetooth, Bluetooth Low Energy (BLE), and/or ZigBee communications), and so forth.

In accordance with the present disclosure, illustrative UAV 160 may include at least a camera 162 and one or more radio frequency (RF) transceivers 166 for cellular communications and/or for non-cellular wireless communications. In one example, UAV 160 may also include a module 164 with one or more additional controllable components, such as a microphone, an infrared, ultraviolet or visible spectrum light source, one or more docking ports, and so forth. It should be noted that UAV 170 may be similarly equipped. However, for ease of illustration, specific labels for such components of UAV 170 may be omitted from FIG. 1.

In addition, in one example, each of: the mobile device 141, access points 196-198, and UAVs 160 and 170 may comprise all or a portion of a computing device or processing system, such as computing system 400 as described in connection with FIG. 4 below, specifically configured to perform various steps, functions, and/or operations in connection with examples of the present disclosure for providing secure data delivery via an uncrewed vehicle.

For instance, owners and/or users of mobile device 141 or remote control device 169 may register with one or more service providers for performing proposed transactions via an uncrewed vehicle. For example, the service provider may comprise: a financial entity such as a bank, a brokerage company, or a securities and cryptocurrency trading; a medical entity such as a hospital or a doctor's office; a searching entity such as a private searching platform (e.g., a privately owned application server that may be situated remotely from a user e.g., located at an access point) that allows users to port in their search requests (e.g., Internet search requests) and to port out search results (e.g., Internet search results); an ordering entity such as a third party entity that will carry out a purchase order on behalf of a user (e.g., buying one or more items such as medications per user requests and delivering the purchased items to an uncrewed vehicle), a utility entity (e.g., an electricity providing company, a natural gas providing company, or a water providing company), or a governmental entity such as a forest fire management entity, a first responder coordination entity, a national guard entity, or a military entity.

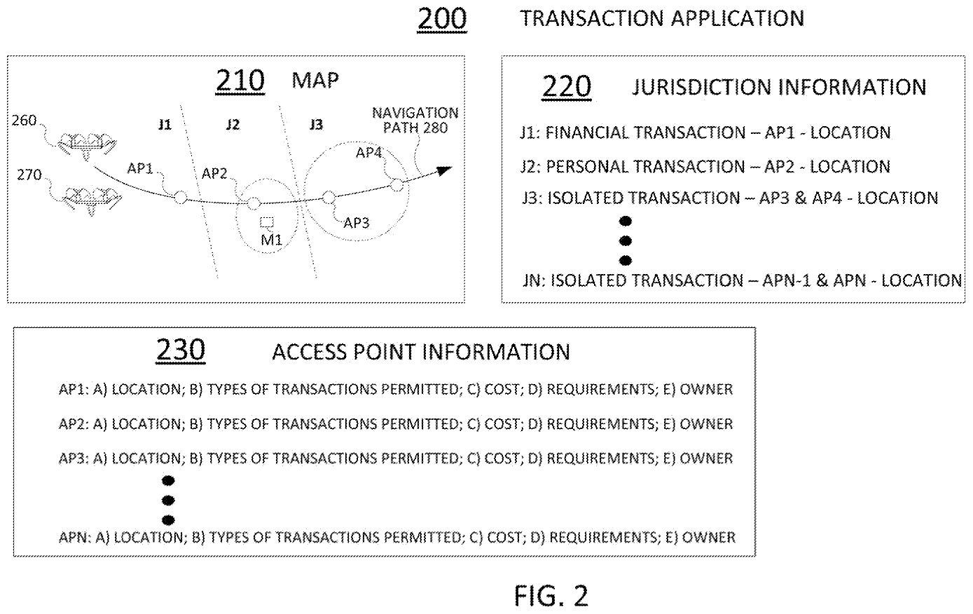

Once registered, the mobile device 141 and/or remote control device 169 may schedule for a proposed transaction to be conducted via an uncrewed vehicle. In one example, UAVs 160 and 170 may similarly be registered for use in connection with providing secure data delivery along a navigation path. For instance, a user of mobile device 141 may wish to conduct a financial transaction, e.g., trading a cryptocurrency from a cold wallet. A transaction software application or applet 200 can be triggered in the mobile device 141 and/or remote control device 169. For example, the transaction application 200 can be triggered from the cold wallet application containing the cryptocurrency, a search function of a browser application, or a dedicated proposed transaction application. To illustrate, if a user wants to trade a cryptocurrency from his or her cold wallet application, by selecting a trade function, the cold wallet application may activate the transaction application 200 that will present one or more user interfaces, e.g., as shown and discussed below in FIG. 2. The user interfaces will allow the user to select a type of transaction and provide one or more parameters associated with the transaction. The user interfaces will allow the user to select a particular geographical region or jurisdiction to execute the transaction. In some examples, the user may even select a particular access point within a selected jurisdiction to conduct the transaction and the user interface may optionally show the navigation path that the uncrewed vehicle will likely take. Once the particulars of the proposed transaction has been provided to the transaction application 200, an executable script (e.g., broadly a program or sequence of instructions that is interpreted or carried out by another program e.g., a website) can be generated by the transaction application 200. In turn, the script can be uploaded to an UAV 160 or 170 registered to a user or a third party entity for providing secure data delivery. In turn, the UAV will travel on a calculated navigation path to a designated access point to deliver or execute the uploaded script. Once the script is completed or executed, the UAV may receive a confirmation of the transaction having been completed or the UAV may receive an output resulting from the execution of the transaction, e.g., receiving a receipt, receiving a search result, receiving additional instructions or commands from a third party entity, and the like. In turn, the UAV may carry the transaction results to its original start position and report back the transaction results, e.g., to the mobile device 141 and/or remote control device 169.

In one example, server(s) 112 (or server 125) may comprise an uncrewed vehicle transaction service. In one example, the service may be provided by a governmental entity that is tasked with regulating and monitoring UAV transaction operations. In another example, the service may be provided by a public-private partnership, or quasi-governmental agency, or a non-governmental entity that is delegated responsibility to fulfill proposed transaction operations. For instance, the server(s) 112 may receive a proposed transaction such as a financial transaction, a personal transaction, or an isolated transaction. Based on the type of the proposed transaction, the server(s) 112 may determine which access points and/or which jurisdictions would be able to conduct the proposed transaction. Once the access points and/or which jurisdictions are determined, calculated navigation paths and/or flight plans for an UAV are reviewed to be approved, denied, or modified. Alternatively, or in addition, the server(s) 112 may obtain desired destination information (e.g., a selected access point) for a UAV (and its current location information), and may calculate, select, and provide navigation paths (and/or flight plans) to such UAV, and/or to operators thereof (e.g., the user who wants to execute the proposed transaction). For instance, server(s) 112 may coordinate among different proposed or candidate navigation paths, and flight plans, for different UAVs which may be seeking to navigate to and from among the regions or jurisdictions 180a-c, e.g., at the same time. Thus, server(s) 112 may obtain information regarding the intended navigation paths of different UAVs, the current locations of these UAVs, conditions along such navigation paths (and/or conditions within the geographical regions or jurisdictions 180a-c in general), the type of proposed transactions to be conducted, the time frame that the proposed transactions must be completed, and the like. Server(s) 112 may then continually monitor for such proposed transaction requests, while denying some proposed transaction requests, approving some proposed transaction requests, or modifying some proposed transaction requests. In other words, server(s) 112 will orchestrate the proposed transaction requests to avoid conflicts, and so forth. In one example, server(s) 112 may also detect deviations from expected conditions along a UAV's navigation path and may take one or several remedial actions, e.g., 1) cancelling the proposed transaction if the proposed transaction has yet to be completed; 2) deleting the script for the proposed transaction from a memory of the UAV; 3) deleting the transaction results from a memory of the UAV if the proposed transaction has been completed; 4) deleting instructions or commands received from a third party after the proposed transaction has been completed; 5) reformatting the entire memory of the UAV so that no traceable information pertaining to the user and/or the transaction can be siphoned from the UAV; 6) extending the time permitted to execute the proposed transaction; 7) modifying the proposed transaction (e.g., changing at least one parameter of the proposed transaction); 8) activating a camera and/or microphone of the UAV to take a picture and/or capture audio of the UAV's immediate surrounding (e.g., to possible detect that an unknown user is proximate to the UAV), and the like. In one embodiment, the remedial actions may depend upon the nature of the deviation, e.g., 1) the UAV is inadvertently off-course, e.g., due to a weather condition, a degradation experienced by the UAV (e.g., loss of power, loss of flight control, loss of navigational control, etc.); 2) the UAV is intentionally steered off-course by a malicious user (e.g., the UAV has been hacked and has been commandeered by a malicious user); 3) a party to the proposed transaction has refused to complete the proposed transaction and the UAV has to detour to an alternate access point for a different party to complete the proposed transaction.

To illustrate, UAV 160 may be commencing a flight along the navigation path 181 to travel to an access point to complete a proposed transaction. In one example, the UAV 160 may be controlled by an operator via remote control device 169. In another example, the UAV 160 may be a self-operating vehicle, or “drone.” In one example, the UAV 160 or an operator, via remote control device 169, may provide a navigation path 181 (e.g., an anticipated or expected navigation path) to server(s) 112. Alternatively, or in addition, the UAV 160 or the operator, via remote control device 169, may provide a desired destination such as a particular access point 196, 197, or 198 (and in one example, a current location of UAV 160) to server(s) 112. Server(s) 112 may then calculate the navigation path 181, and provide the navigation path 181 to UAV 160 and/or remote control device 169. In one example, the navigation path 181 comprises a set of expected positions and times such as T1-T4. For instance, the navigation path may include a first position at a time T1. In other words, the UAV 160 is expected to be at or near the first position on or around time T1 in accordance with the navigation path 181. Similarly, UAV 160 may be expected to be at or near a second position on or around time T2, and likewise for a third position for time T3 and a fourth position for time T4.

It should be noted that the positions and times T1-T4 may be approximate so as to allow some latitude in the fight path, the speed of the flight, traffic congestion, the current weather conditions such as wind, the time needed to execute a proposed transaction at one of the access point 196, 197, or 198, and etc. For instance, server(s) 112 may provide approval for the navigation path 181, within a certain time limit, or time limits of validity. For instance, the UAV 160 may be cleared and permitted to fly over the second position during a two minute time interval, a four minute time interval, etc. after which, other aerial vehicles may be expected and/or permitted to be in substantially the same space (e.g., at or near the second position, within a distance that would be deemed unsafe if UAV 160 were still at the second position at such time).

In accordance with the present disclosure, server(s) 112 may determine expected conditions along the navigation path 181. For instance, the set of positions-time pairs and the estimated time needed to complete a particular type of transaction may be considered expected conditions along the navigation path 181. In addition, expected conditions may include weather conditions and the presence and/or state of possible obstructions along the navigation path 181. In one example, the weather conditions may include a visibility level, a condition of snow, rain, hail, and/or sleet (or a lack thereof), a wind speed or wind speed level (e.g., force 3, force 5, etc.), and so forth. As noted above, the weather conditions may be obtained from a weather data service (WDS) (e.g., represented by one or more of server(s) 125). For instance, the WDS may provide weather forecasts relating to one or more types of weather conditions for locations (or positions in three-dimensional space) of geographical regions or jurisdictions 180a-c.

In one example, possible obstructions within regions or jurisdictions 180a-c may be determined in accordance with topographical information maintained by server(s) 112. For instance, as noted above server(s) 112 may obtain a digital elevation model (DEM) for regions or jurisdictions 180a-c. Thus, varying terrain may be identified from the DEM. For instance, server(s) 112 may determine that navigation path 181 should include a flight level above 500 meters (at least in part) due to mountainous terrain (along at least part of the navigation path 181) that exceeds 450 meters. In other words, at least a 50 meter buffer over such obstruction may be included in the navigation path 181. It should be noted possible “obstructions” within regions or jurisdictions 180a-c may include possible malicious users along the navigation path who may intend on harming the UAVs and/or foiling the completion of the transactions of the UAVs. For example, to avoid being hit by a projectile launched by the malicious users, the UAV may take a flight path that avoids a direct line of sight with the malicious users.

In addition, in accordance with the present disclosure server(s) 112 may maintain additional obstruction information, e.g., as part of the digital elevation model and/or in a separate data storage component that is linked to the digital elevation model. For example, server(s) 112 may build and maintain an information database regarding non-topological obstructions, which may include buildings, towers (e.g., radio broadcast towers, cellular base station towers, towers for roller-coasters or other amusement park rides, airport control towers, etc.), and so forth. Thus, non-topological obstructions that may be expected along expected navigation path 181 may also be identified by server(s) 112. In one example, the server(s) 112 may alter navigation path 181, e.g., where navigation path 181 is submitted to server(s) 112 for approval and an obstruction is identified on the navigation path 181 (e.g., within a distance range of a center line of the navigation path 181 such that the obstruction may be considered a non-zero risk). In one example, server(s) 112 may approve the navigation path 181, but may provide a notification to the UAV 160 and/or an operator thereof (e.g., at remote control device 169) of the obstruction, e.g., including information regarding the characteristics thereof and the location, or position of the obstruction).

In one example, the information database of obstructions may comprise information that is obtained fully or partially from another party. For instance, one or more of server(s) 125 may represent resources of a service for maintaining and providing obstruction information. Thus, for instance, server(s) 112 may in one example subscribe to such a service and obtain such information from the one or more of server(s) 125. For example, in accordance with such a service, UAVs may be tasked with supplementing GIS topology information with more specific measurements of smaller areas within regions or jurisdictions 180a-c. For instance, UAVs may capture location and visual information to help build object models, and to place such models at locations/positions within the digital elevation model for regions or jurisdictions 180a-c. For example, UAVs (such as UAVs 160 and 170) may be used to capture measurements of physical properties of towers, buildings, and so on.

Server(s) 125 may receive and process these measurements to learn an object model. In one example, object models may be learned from the captured data via a generative adversarial network (GAN) learning process. For instance, server(s) 125 may learn a generator function and a discriminator (e.g., an object mode) for each object (such as a building, a tower, etc.) that is being modeled. In one example, server(s) 125 may provide instructions to UAVs to capture additional measurements of physical properties of an object by repositioning, reorienting cameras, and so on. In one example, the learning of object models and the placement of such models at appropriate geographic locations (e.g., within a digital elevation model, or the like) may have human involvement and direction in terms of selecting locations or areas to be surveyed, providing UAVs for such surveying, maintaining such UAVs, and so forth. Alternatively, or in addition, UAV services for such surveying may be crowd-sourced by soliciting assistance from individual UAV owners and/or operators who may be willing to provide the use of their equipment for the purpose of such surveying.

In any case, server(s) 112 may obtain obstruction information from server(s) 125, and store such obstruction information for subsequent retrieval and use in connection with verifying navigation paths for UAVs, as described herein. Alternatively, or in addition, server(s) 112 may build and maintain object model, e.g., in the same or substantially similar manner as described above in connection with server(s) 125. For instance, an operator of telecommunication network 110 may build and maintain a database of obstruction information, e.g., in addition to voice, television, and data communication services.

In one example, an information database of access points may comprise access point information that is obtained fully or partially from another party. For instance, one or more of server(s) 125 may represent resources of a service for maintaining and providing access point information. Thus, for instance, server(s) 112 may in one example subscribe to such a service and obtain such access point information from the one or more of server(s) 125. For example, in accordance with such a service, different owners of different access points may broadcast or provide specifications of the access points, e.g., 1) the type of transactions permitted to be executed at a particular access point; 2) the number of transactions that can be executed at a given time at a particular access point (e.g., processing bandwidth or transmission bandwidth); 3) the cost associated with each type of transaction being executed at a particular access point; 4) the owner information (e.g., a private owner of a decentralized network or a large corporate communication service provider owner) of a particular access point; or 5) the number particular access points needed for a particular type of transaction e.g., for some highly sensitive transactions, multiple access points may be needed such as sending two UAVs to two different access points with the proposed transaction being broken into two separate distinct sub-transactions. The proposed transaction is only deemed to be completed when both sub-transactions are completed. Alternatively, multiple access points may also be needed such as sending two UAVs to two different access points with a single proposed transaction being broken into at least two separate portions. Thus, one portion is sent to a first access point, whereas another portion is sent to a second access point. Although there is only a single proposed transaction, the two separate portions must be obtained from two separate access points and then reassembled back into a single proposed transaction that can then be executed properly.

In any case, server(s) 112 may obtain access point information from server(s) 125, and store such access point information for subsequent retrieval and use in connection with providing secure data delivery via an uncrewed vehicle, as described herein. Alternatively, or in addition, server(s) 112 may build and maintain object model, e.g., in the same or substantially similar manner as described above in connection with server(s) 125. For instance, an operator of communication network 110 may build and maintain a database of access point information, e.g., in addition to voice, television, and data communication services.

To illustrate, a user located in geographical region or jurisdiction 1 180a may upload a script for a proposed transaction from mobile device 141 to UAV 160 to be executed in ether geographical region or jurisdiction 2 180b or geographical region or jurisdiction 3 180c. In this example, a navigation path 181 has been calculated (e.g., by mobile device 141 or server (112)) for UAV 160. Once the script is uploaded, UAV 160 travels to geographical region or jurisdiction 2 180b where either of the two access points 196 and 197 can be utilized to executed the proposed transaction. However, in a second scenario, due to the type of the proposed transaction only one of the two access points 196 and 197 can be utilized to execute the proposed transaction, e.g., access point 196 is only used to support financial transaction whereas access point 197 can be utilized to only to support personal transaction, and so on. In yet another scenario, the proposed transaction may require two UAVs 160 and 170 to properly carry out a single transaction. For example, the single transaction is broken into two portions where each of the two UAVs 160 and 170 carries one portion and must travel to its corresponding access point 196 or 197 to offload the two distinct portions. Once both portions are received, e.g., by an application server or a website performing the proposed transactions, then the execution of the proposed transaction may proceed. Alternative, the single transaction is broken into two distinct sub-transactions where each of the two UAVs 160 and 170 is tasked with carrying out one of the two sub-transactions and must travel to its corresponding access point 196 or 197 (e.g., one sub-transaction is for authenticating the user of the proposed transaction with a first website, where the first website will then coordinate with a second website to allow the other sub-transaction to be executed). Once both sub-transactions are executed, e.g., by one or more application servers or websites, then the results of the proposed transaction may be generated.

In one embodiment, if the access points 196 and 197 of geographical region or jurisdiction 180b are not available, then UAV 160 may continue on the navigation path 181 to reach an alternate or backup geographical region or jurisdiction 180c. In other words, the proposed transaction can be executed via access point 198 of geographical region or jurisdiction 180c.

In another embodiment, UAVs 160 and/or 170 may be owned by a transaction service provider instead of an individual user. In this scenario, the transaction service provider may send their UAVs 160 and/or 170 into the geographical region or jurisdiction 180a of the user of mobile device 14 to effect the transaction. For example, the user may access a website of the transaction service provider to submit a proposed transaction with the pertinent transaction parameters. Once the proposed transaction is deemed to be executable, then the transaction service provider may send their UAVs 160 and/or 170 into the geographical region or jurisdiction 180a of the user of mobile device 141, e.g., the user may have purchased a cryptocurrency and the cryptocurrency exchange (e.g., a transaction service provider) may direct UAV 170 to download the purchased cryptocurrency to the user's cold wallet.

In one example, the method for providing secure data delivery via an uncrewed vehicle may be performed in accordance with one or more artificial intelligence or machine learning algorithms (MLAs), e.g., one or more trained machine learning models (MLMs). In one embodiment, server 112 may employ one or more trained machine learning models (MLMs) to orchestrate the handling of proposed transactions from a plurality of users, e.g., determining the navigation path and/or the assignment of one or more access points within one or more jurisdictions for each of the proposed transactions. For instance, a machine learning algorithm (MLA), or machine learning model (MLM) trained via a MLA may be for detecting a single item, or may be for detecting a single item from a plurality of possible items that may be detected via the MLA/MLM. For instance, the MLA (or the trained MLM) may comprise a deep learning neural network, or deep neural network (DNN), a generative adversarial network (GAN), a support vector machine (SVM), e.g., a binary, non-binary, or multi-class classifier, a linear or non-linear classifier, and so forth. In one example, the MLA/MLM may be a SIFT or SURF features-based detection model, as mentioned above. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. It should be noted that various other types of MLAs and/or MLMs may be implemented in examples of the present disclosure, such as k-means clustering and/or k-nearest neighbor (KNN) predictive models, support vector machine (SVM)-based classifiers, e.g., a binary classifier and/or a linear binary classifier, a multi-class classifier, a kernel-based SVM, etc., a distance-based classifier, e.g., a Euclidean distance-based classifier, or the like, and so on. In one example, the item detection MLM(s) may be trained at a network-based processing system (e.g., server(s) 112, server(s) 125, or the like).

The foregoing illustrates just one example of providing secure data delivery via an uncrewed vehicle, in accordance with the present disclosure. Additional examples are illustrated in the transaction application of FIG. 2 and described in greater detail below.

It should also be noted that the system 100 has been simplified. In other words, the system 100 may be implemented in a different form than that illustrated in FIG. 1. For example, the system 100 may be expanded to include additional networks, and additional network elements (not shown) such as wireless transceivers and/or base stations, border elements, routers, switches, policy servers, security devices, gateways, a network operations center (NOC), a content distribution network (CDN) and the like, without altering the scope of the present disclosure. In addition, system 100 may be altered to omit various elements, substitute elements for devices that perform the same or similar functions and/or combine elements that are illustrated as separate devices.

As just one example, one or more operations described above with respect to server(s) 112 may alternatively or additionally be performed by server(s) 125, and vice versa. In addition, although server(s) 112 and 125 are illustrated in the example of FIG. 1, in other, further, and different examples, the same or similar functions may be distributed among multiple other devices and/or systems within the telecommunication network 110, wireless access network(s) 115, and/or the system 100 in general that may collectively provide various services in connection with examples of the present disclosure for providing secure data delivery via an uncrewed vehicle.

Additionally, devices that are illustrated and/or described as using one form of communication (such as a cellular or non-cellular wireless communications, wired communications, etc.) may alternatively or additionally utilize one or more other forms of communication. For instance, access points 196-198 may alternatively or additionally be equipped for cellular communications, wireless wide-area network (WWAN) communications, and so forth. In such examples, access points 196-198 may communicate with other devices or systems, such as server(s) 125 and/or server(s) 112, via base stations 117 and/or 118, wireless access network(s) 115, and so forth. Thus, these and other modifications are all contemplated within the scope of the present disclosure.

FIG. 2 illustrates an example transaction application 200 with a plurality of user interfaces 210, 220, and 230. In one embodiment, transaction application 200 is activated when a user manually launches the transaction application 200 or when another software application (e.g., a browser application) activates the transaction application 200. For example, a browser application may be configured when certain search terms are entered by a user (e.g., divorce attorney), the browser application may query the user as to whether a proposed transaction function via an UAV is required. If the query is affirmatively answered, then the transaction application 200 is launched by the browser application, e.g., via usage of Application Programming Interfaces (APIs).

FIG. 2 illustrates three illustrative interfaces, 210, 220, and 230. In one embodiment, user interface 210 shows a map of a plurality of jurisdictions (e.g., J1-J3) and corresponding access points (e.g., AP1-AP4). The map 210 also shows one or more UAVs 260-270 along a navigation path 280. The map 210 also illustrates certain jurisdictions having multiple access points (e.g., J3 having AP3 and AP4). Furthermore, some jurisdiction may have additional hardware devices in addition to the access point. For example, some jurisdictions may employ a monitor (e.g., an application server such as M1) that is tasked with monitoring the operation of the access point with an UAV. The monitor may include a camera to monitor the traversals of UAVs to and from the access point. The monitor may perform additional functions such as: authenticating an UAV, registering an UAV, charging an UAV, executing a software script for an UAV, capturing an image of the UAV, and so on. In one embodiment, map 210 allows a user to visually track the progress of a dispatched UAV in real time for executing a transaction along a navigation path. Since the proposed transaction may be deemed to be a high value transaction, the user may want to track the transaction visually in the event that a remedial action is desired. For example, if the user sees a deviation of the UAV from its intended navigation path 280 without a corresponding reasonable explanation, the user may trigger one or more remedial actions, e.g., abort the transaction and direct the UAV to return home immediately, and so on.

In one embodiment, user interface 220 shows jurisdiction information for various jurisdictions e.g., that the UAV may traverse for a given navigation path or all available jurisdictions for one or more proposed transactions. For example, for each jurisdiction, the jurisdiction information may comprise: 1) the type(s) of transaction supported by each jurisdiction; 2) the number of access points for each jurisdiction; or 3) the location, size and/or boundaries of the access points and/or jurisdictions.

In one embodiment, user interface 230 shows access point information for various jurisdictions e.g., that the UAV may traverse to for a given navigation path or all available jurisdictions for one or more proposed transactions. For example, for each access point, the access point information may comprise: 1) the type(s) of transaction supported by each access point; 2) the cost of each access point for executing or assisting the executing of a transaction; 3) the location, size and/or coverage boundaries of each access point; 4) the requirements of each access point such as a duration of use, UAV charging capability, communication protocol(s), encryption protocol(s), or compression protocol(s) supported by each access point; or 5) the owner (e.g., a private owner or a corporate service provider owner) of each access point. Thus, transaction application 200 allows a user or a service provider entity to easily define and track the execution of a proposed transaction via the use of one or more UAVs.

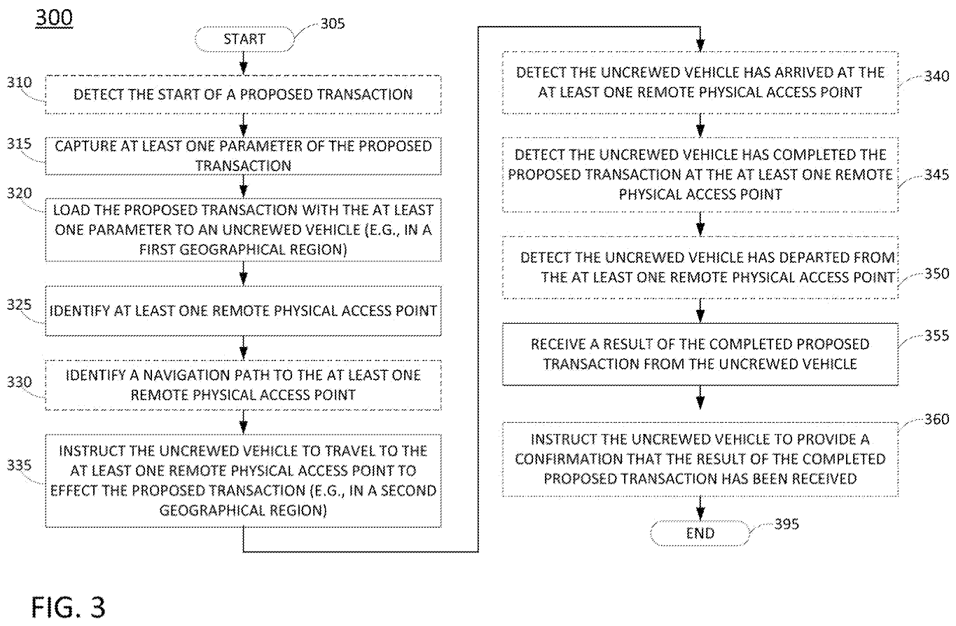

FIG. 3 illustrates a flowchart of an example method 300 for providing secure data delivery via an uncrewed vehicle. In one example, steps, functions and/or operations of the method 300 may be performed by a device and/or processing system as illustrated in FIG. 1, e.g., by one or more of server(s) 112, or any one or more components thereof, or by server(s) 112 and/or any one or more components thereof in conjunction with one or more other components of the system 100, such as one or more of server(s) 125, elements of wireless access network 115, communication network 110, any mobile device 141 and access points 196-198, and so forth. In one example, the steps, functions, or operations of method 300 may be performed by a computing device or processing system, such as computing system 400 and/or hardware processor element 402 as described in connection with FIG. 4 below. For instance, the computing system 400 may represent any one or more components of the system 100 that is/are configured to perform the steps, functions and/or operations of the method 300. Similarly, in one example, the steps, functions, or operations of the method 300 may be performed by a processing system comprising one or more computing devices collectively configured to perform various steps, functions, and/or operations of the method 300. For instance, multiple instances of the computing system 400 may collectively function as a processing system. For illustrative purposes, the method 300 is described in greater detail below in connection with an example performed by a processing system. The method 300 begins in step 305 and proceeds to step 310.

At optional step 310, the processing system detects the start of a proposed transaction. For example, certain triggers may be detected that a user may want to start a proposed transaction that will utilize a UAV delivery service to assist in executing the transaction (e.g., broadly an electronic based transaction over a network). For example, a browser application may be configured when certain search terms are entered by a user (e.g., divorce attorney, mental illness treatments, advises on reproductive care issues, and so on), the browser application may query the user as to whether a proposed transaction function via an UAV is required. If the query is affirmatively answered, then the transaction application 200 is launched by the browser application, e.g., via usage of Application Programming Interfaces (APIs). Similarly, if the user launches a particular type of software application, e.g., a dedicated software application that necessitates the use of a UAV delivery service to assist in executing the transaction, then the start of a proposed transaction is detected. For example, when a firing solution software for computing the delivery of an explosive ordinance against a particular target is launched, then the start of a proposed transaction is detected. In other words, certain software applications will always trigger the detection of the start of a proposed transaction that will utilize a UAV delivery service.

At step 315, the processing system captures or stores at least one parameter associated with a proposed transaction. For example, the at least one parameter may comprise one or more of: 1) a timing associated with the proposed transaction (e.g., when the transaction should be executed such as a specified time), 2) a currency value associated with the proposed transaction parameter (e.g., a dollar value of the completed transaction such as a price of the sold security), 3) a physical location associated with the proposed transaction (e.g., where the transaction should be executed such as a delivery of a purchased item), 4) a transaction result handling procedure associated with the proposed transaction (e.g., how the transaction results should be stored or forwarded to a user's device), 5) a quantity value associated with the proposed transaction (e.g., the number of units for the transaction such as the number of returned search results, the number of searches, the number of stocks to be purchased, and so on), 6) a conditional event associated with the proposed transaction (e.g., a conditional event that must occur first before the transaction can be executed), 7) an alternate execution procedure associated with the proposed transaction (e.g., what to do when the transaction fails to be executed such as conducting the transaction at a different access point, exchange or venue), and the like.

At step 320, the processing system loads the proposed transaction onto an uncrewed vehicle, e.g., an UAV, for providing secure data delivery. In one embodiment, one or more UAVs in communication with a mobile device 141 or a remote control device 169 will receive a software script representing the proposed transaction with the at least one transaction parameter. In one embodiment, the proposed transaction (or the software script containing the proposed transaction) is encrypted, e.g., using a pair of encryption keys where the sender has a first encryption key for encryption and the recipient of the proposed transaction has a second encryption key for decrypting the encrypted proposed transaction. This added security will protect the proposed transaction in the event that the uncrewed vehicle is intercepted by a malicious party.

At step 325, the processing system identifies at least one physical access point for effecting the proposed transaction. In other words, the identified at least one access point will be the network connectivity point that will allow the proposed transaction to be forwarded to the proper destination for execution, e.g., a dedicated application server or a web site. The at least one access point (e.g., located in geographical region 2) is physically remote from the location (e.g., located in geographical region 1) of a user device of the user who formulated the proposed transaction.

At optional step 330, the processing system identifies a navigation path to the at least one access point identified at step 325. In one embodiment, the one or more UAVs may also receive one or more navigation paths that define the flight path(s) to one or more specified access points to effect the execution of the proposed transaction. The navigation path(s) can be provided by: the mobile device 141 or a remote control device 169, the server (s) 112 or 125, or the one or more UAVs may be given the identification of the designated access point(s) and the one or more UAVs themselves can map a route to the designated access point(s). If the one or more UAVs are given the identification of the designated access point(s) and the one or more UAVs themselves are mapping a route to the designated access point(s), then step 330 is considered optional.

At step 335, the processing system instructs the uncrewed vehicle to travel to the at least one access point to effect the proposed transaction. In other words, the uncrewed vehicle is instructed to take off and travel to the at least one access point. In one embodiment, upon arrival, the uncrewed vehicle will effect the proposed transaction. For example, the uncrewed vehicle may serve as a user endpoint device such as mobile device 141 for conducting the proposed transaction. Thus, as an example the loaded script can be executed by the uncrewed vehicle on behalf of the mobile device 141 by connected to the at least one access point. It should be noted that travelling to the at least one access point comprises traveling to within a communication range of the at least one access point. Within the communication range may comprise hovering near the at least one access point or actually landing on a landing pad provided for the at least one access point. If the uncrewed vehicle physically lands on the landing pad, then communication may be provided via wireless or wired connectivity.

At optional step 340, the processing system detects the uncrewed vehicle's arrival at the at least one access point. For example, the uncrewed vehicle may transmit a confirmation back to the mobile device 141 that the uncrewed vehicle is within range of the at least one access point and/or network connectivity has been established through the at least one access point. For example, in one embodiment, a user may want to track the progress of the uncrewed vehicle's travel to the at least one access point.

At optional step 345, the processing system detects the uncrewed vehicle's completion of the proposed transaction at the at least one access point. For example, the uncrewed vehicle may transmit a confirmation back to the mobile device 141 that the proposed transaction has been completed and/or network connectivity has been terminated with the at least one access point. For example, in one embodiment, a user may want to track the progress of the uncrewed vehicle's delivery and/or execution of the proposed transaction at the at least one access point.

At optional step 350, the processing system detects the uncrewed vehicle's departure from the at least one access point. For example, the uncrewed vehicle may transmit a confirmation back to the mobile device 141 that the uncrewed vehicle is no longer within range of the at least one access point and/or network connectivity has been terminated with the at least one access point. For example, in one embodiment, a user may want to track the progress of the uncrewed vehicle's travel from the at least one access point. It should be noted that the detecting steps of 340-350 may also include the ability to trigger one or more remedial actions as discussed above. In other words, if a malicious action is detected within these steps, the processing system has the ability to trigger one or more remedial actions to protect the information relating to the proposed transaction and/or the results arising from the completion of the proposed transaction.

At step 355, the processing system receives a result of the completed proposed transaction from the uncrewed vehicle. For example, the results stored on the uncrewed vehicle can be downloaded to the mobile device 141 or remote control device 169.

At optional step 360, the processing system instructs the uncrewed vehicle to again travel to the at least one access point to effect the reporting of a confirmation that the results of the completed proposed transaction has been received. In other words, the other party to the proposed transaction (e.g., a third party service provider) can be informed that the transaction results have been received by the user. In one embodiment, step 360 comprises similar steps to that of steps 335-350 with the exception instead of carrying a proposed transaction, the uncrewed vehicle is carrying a confirmation instead. Namely, the processing system may instruct the uncrewed vehicle to return to the at least one access point to deliver the confirmation.

Following step 355, or optional step 360 the method 300 may proceed to step 395. At step 395, the method 300 ends.

It should be noted that the method 300 may be expanded to include additional steps, or may be modified to replace steps with different steps, to combine steps, to omit steps, to perform steps in a different order, and so forth. For instance, in one example the processing system may repeat one or more steps of the method 300, such as steps 310-335, steps 340-350, steps 315-355, etc. For instance, the processing system may detect an access point denying service to the uncrewed vehicle and may transmit an alternate navigation path to the uncrewed vehicle. The processing system may then repeat steps 325-355 to monitor for the travel along the alternative navigation path to effect the proposed transaction at a different access point. In another example, the method may determine that a second uncrewed vehicle is needed to effect the proposed transaction. In such scenario, one or more steps of steps 310-355 can be applied to the second uncrewed vehicle, as needed. Thus, these and other modifications are all contemplated within the scope of the present disclosure.

In addition, although not expressly specified above, one or more steps of the method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 3 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the example embodiments of the present disclosure.

FIG. 4 depicts a high-level block diagram of a computing system 400 (e.g., a computing device or processing system) specifically programmed to perform the functions described herein. For example, any one or more components, devices, and/or systems illustrated in FIG. 1 or FIG. 2, or described in connection with FIGS. 1-3, may be implemented as the computing system 400. As depicted in FIG. 4, the computing system 400 comprises a hardware processor element 402 (e.g., comprising one or more hardware processors, which may include one or more microprocessor(s), one or more central processing units (CPUs), and/or the like, where the hardware processor element 402 may also represent one example of a “processing system” as referred to herein), a memory 404, (e.g., random access memory (RAM), read only memory (ROM), a disk drive, an optical drive, a magnetic drive, and/or a Universal Serial Bus (USB) drive), a module 405 for providing secure data delivery via an uncrewed vehicle, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 402 is shown, the computing system 400 may employ a plurality of hardware processor elements. Furthermore, although only one computing device is shown in FIG. 4, if the method(s) as discussed above is implemented in a distributed or parallel manner for a particular illustrative example, e.g., the steps of the above method(s) or the entire method(s) are implemented across multiple or parallel computing devices, then the computing system 400 of FIG. 4 may represent each of those multiple or parallel computing devices. Furthermore, one or more hardware processor elements (e.g., hardware processor element 402) can be utilized in supporting a virtualized or shared computing environment. The virtualized computing environment may support one or more virtual machines which may be configured to operate as computers, servers, or other computing devices. In such virtualized virtual machines, hardware components such as hardware processors and computer-readable storage devices may be virtualized or logically represented. The hardware processor element 402 can also be configured or programmed to cause other devices to perform one or more operations as discussed above. In other words, the hardware processor element 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer-readable instructions pertaining to the method(s) discussed above can be used to configure one or more hardware processor elements to perform the steps, functions and/or operations of the above disclosed method(s). In one example, instructions and data for the present module 405 for providing secure data delivery via an uncrewed vehicle (e.g., a software program comprising computer-executable instructions) can be loaded into memory 404 and executed by hardware processor element 402 to implement the steps, functions or operations as discussed above in connection with the example method(s). Furthermore, when a hardware processor element executes instructions to perform operations, this could include the hardware processor element performing the operations directly and/or facilitating, directing, or cooperating with one or more additional hardware devices or components (e.g., a co-processor and the like) to perform the operations.

The processor (e.g., hardware processor element 402) executing the computer-readable instructions relating to the above described method(s) can be perceived as a programmed processor or a specialized processor. As such, the present module 405 for providing secure data delivery via an uncrewed vehicle (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium may comprise a physical device, a hardware device, or a device that is discernible by the touch. More specifically, the computer-readable storage device or medium may comprise any physical devices that provide the ability to store information such as instructions and/or data to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method comprising:
loading, by a processing system including at least one processor, a proposed transaction to at least one uncrewed vehicle while the at least one uncrewed vehicle is situated in a first geographical region;
instructing, by the processing system, the at least one uncrewed vehicle to travel to at least one access point situated in a second geographical region to execute the proposed transaction via the at least one access point, wherein the first geographical region is different from the second geographical region; and
receiving, by the processing system, a result of the proposed transaction having been completed from the at least one uncrewed vehicle via the at least one access point.

2. The method of claim 1, wherein the proposed transaction is encrypted.

3. The method of claim 1, wherein the proposed transaction is embodied in a software script.

4. The method of claim 1, wherein the at least one uncrewed vehicle travels along a navigation path to reach the at least one access point.

5. The method of claim 4, further comprising:
calculating, by the processing system, the navigation path; and
loading, by the processing system, the navigation path to the at least one uncrewed vehicle.

6. The method of claim 4, wherein the navigation path is generated by the at least one uncrewed vehicle.

7. The method of claim 4, wherein the navigation path is generated by a remote server and then provided to the at least one uncrewed vehicle, wherein the remote server is distinct from the processing system.

8. The method of claim 4, further comprising:
detecting, by the processing system, a deviation from the navigation path by the at least one uncrewed vehicle; and
instructing, by the processing system, the at least one uncrewed vehicle to execute a remedial action in response to the deviation from the navigation path.

9. The method of claim 1, wherein the proposed transaction comprises at least one parameter comprising at least one of:
a timing associated with the proposed transaction;
a currency value associated with the proposed transaction;
a physical location associated with the proposed transaction;
a transaction result handling procedure associated with the proposed transaction;
a quantity value associated with the proposed transaction;
a conditional event associated with the proposed transaction; or
an alternate execution procedure associated with the proposed transaction.

10. The method of claim 1, further comprising:
detecting, by the processing system, the at least one uncrewed vehicle has arrived at the at least one access point.

11. The method of claim 10, further comprising:
detecting, by the processing system, the at least one uncrewed vehicle has completed the proposed transaction at the at least one access point.

12. The method of claim 11, further comprising:
detecting, by the processing system, the at least one uncrewed vehicle has departed from the at least one access point.

13. The method of claim 1, further comprising:
instructing, by the processing system, the at least one uncrewed vehicle to provide a confirmation that the result of the proposed transaction has been received by a sender of the proposed transaction.

14. The method of claim 13, wherein the instructing the at least one uncrewed vehicle to provide the confirmation comprises instructing the uncrewed vehicle to return to the at least one access point to deliver the confirmation.

15. The method of claim 1, wherein the proposed transaction having at least one parameter of the proposed transaction is captured via a transaction application deployed in a mobile device of a user.

16. The method of claim 15, wherein the transaction application has a plurality of user interfaces comprising at least one of:
a map interface;
a jurisdiction information interface; or
an access point information interface.

17. The method of claim 16, wherein the map interface presents a visual presentation of a navigation path to be taken by the at least one uncrewed vehicle to reach the at least one access point, wherein the jurisdiction information interface presents a plurality of jurisdictions that the proposed transaction can be effected, the plurality of jurisdictions including the second geographical region, and wherein the access point information interface presents a plurality of the access points that the proposed transaction can be effected, the plurality of the access points including the at least one access point.

18. The method of claim 1, wherein the at least one uncrewed vehicle comprises a first uncrewed vehicle and a second uncrewed vehicle, wherein the at least one access point comprises a first access point and a second access point, wherein the proposed transaction has a first portion and a second port, wherein the first uncrewed vehicle is instructed to travel to the first access point to effect a completion of the first portion of the proposed transaction, and wherein the second uncrewed vehicle is instructed to travel to the second access point to effect a completion of the second portion of the proposed transaction.

19. A non-transitory computer-readable medium storing instructions which, when executed by a processing system including at least one processor, cause the processing system to perform operations, the operations comprising:
loading a proposed transaction to at least one uncrewed vehicle while the at least one uncrewed vehicle is situated in a first geographical region;
instructing the at least one uncrewed vehicle to travel to at least one access point situated in a second geographical region to execute the proposed transaction via the at least one access point, wherein the first geographical region is different from the second geographical region; and
receiving a result of the proposed transaction having been completed from the at least one uncrewed vehicle via the at least one access point.

20. A device comprising:
a processing system including at least one processor; and
a computer-readable medium storing instructions which, when executed by the processing system, cause the processing system to perform operations, the operations comprising:
loading a proposed transaction to at least one uncrewed vehicle while the at least one uncrewed vehicle is situated in a first geographical region;
instructing the at least one uncrewed vehicle to travel to at least one access point situated in a second geographical region to execute the proposed transaction via the at least one access point, wherein the first geographical region is different from the second geographical region; and
receiving a result of the proposed transaction having been completed from the at least one uncrewed vehicle via the at least one access point.
